(19) United States
(12) Patent Application Publication
(10) Pub. No.: US 2005/0265134 A1
(43) Pub. Date: Dec. 1, 2005

(54) Optical recording material, optical recording medium and optical recording/reproducing device

(75) Inventors: Jiro Minabe, Ashigarakami-gun (JP); Shin Yasuda, Ashigarakami-gun (JP); Hiroo Takizawa, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/037,359

(22) Filed: Jan. 19, 2005

(30) Foreign Application Priority Data
Jun. 1, 2004 (JP) 2004-163889

(51) Int. Cl. G11B 11/00

(52) U.S. Cl. 369/13.17

(57) ABSTRACT

The present invention provides an optical recording material for recording information by utilizing a change in absorption, a change in refractive index or a change in shape accompanying irradiation with light. The optical recording material includes a polymer or an oligomer which has a side chain containing one or more mesogenic groups and linked to a main chain and which contains two or more kinds of photoresponsive groups, each of which are different in absorption spectrum. The invention also provides an optical recording medium containing the optical recording material in a photosensitive layer. Further, the invention provides an optical recording reproduction apparatus for recording and/or reproducing information by using the optical recording medium.

### CROSS-REFERENCE TO RELATED APPLICATION

This application claims priority under 35 USC 119 from Japanese Patent Application No. 2004-163889, the disclosure of which is incorporated by reference herein.

### BACKGROUND OF THE INVENTION

1. Field of the Invention

The present invention relates to an optical recording material, an optical recording medium and an optical recording/reproducing device. In particular, the invention relates to a volume-type optical recording medium having a large-capacity, an optical recording material for use in such an optical recording medium, and an optical recording/reproducing device which uses such an optical recording medium for purpose of recording and reproducing information.

2. Description of the Related Art

In order to secure an increasingly high level of recording density, conventional, high-density, large-capacity, optical disc storage devices have been designed so as to have a small beam-spot diameter and a short distance between adjacent tracks or pits. However, the in-plane recording of data on such an optical disc is restricted by the diffraction limit of light, and the conventional high density recording is now approaching its physical limits (5 Gbit/in²). Thus, three-dimensional (volume) recording (including recording in the depth direction) is necessary to secure a further increase in capacity.

As a volume-type optical recording medium of the type mentioned above, a medium comprising a photorefractive material (a photorefractive material medium) on which volume recording of holographic gratings can be performed is regarded as promising. It is known that some photorefractive materials (hereinafter referred to as “PR materials”) have a high degree of sensitivity, and therefore they can change their refractive index by absorbing relatively weak light to the same extent as a solid-state laser. Such materials are expected to be applied to volume-multiplexed holographic recordings (holographic memories) which can assume an ultra-high density and an ultra-large capacity.

The principle of the photorefractive effect is now described. Two coherent lightwaves are applied to the PR material to form interference. In places where light intensity is high, electrons at the donor level are excited to the conduction band and either diffuse or drift into a place where light intensity is low. Positive charges are left in places where light intensity is high, and negative charges accumulate in places where light intensity is low. Thus, charge distribution is formed to create an electrostatic field. The electro-optical effects of the electrostatic field result in variations in the refractive index. The cycle of variations in the refractive index is the same as the cycle of the interference fringes, and refractive index gratings act as holographic diffraction gratings.

Conventionally, inorganic ferroelectric crystal materials such as barium titanate, lithium niobate and bismuth silicate (BSO) have often been used as the PR material. These materials can demonstrate a photo-induced refractive index-varying effect (photorefractive effect) with a high level of sensitivity and a high degree of efficiency. On the other hand, these materials also entail a number of disadvantages, insofar that crystal growth has proved difficult in the case of many of these materials, many of the materials are also hard and brittle, and thus cannot be worked into a desired shape, and regulation of sensitive wavelengths has also proved difficult.

In recent years, organic PR materials have been proposed for overcoming such disadvantages. In general, such organic PR materials are composed of (i) a charge-generating material that generates charges on receiving light; (ii) a charge transfer material that stimulates the transfer of generated charges inside a medium; (iii) a dichroic organic dye which is sensitive to the electric field induced by the transfer of charges; (iv) a polymer substrate (binder) which supports these materials; and (v) additives (such as plasticizers and compatibility-improving agents) for modifying the physical properties of the substrate. A single component may play different roles, for example, as both the charge transfer material and the polymer substrate, or as the charge transfer material and the plasticizer.

In such organic PR materials, the charge-generating material absorbs light to generate both positive and negative charges. The charge transfer material enables the charges to separate into positive and negative charges by means of the action of the existing outer electric field, and an inner electric field is thus produced. The inner electric field produces variations in the orientation of the dichroic dye, which leads to variations in refractive index distribution within the substrate. With the use of such organic PR materials, therefore, high-density volume holographic recording is in theory considered to be possible.

However, such organic PR materials entail a problem insofar that they inherently require the application of an outer electric field. The electric field is as remarkably large as several hundreds V·mm⁻¹, and in the practical use of the material system for recording devices this imposes a severe restriction on the size of devices. Insofar that a mixture of several different materials including the charge-generating material, the charge transfer material and the polymer substrate, this material system also involves a significant problem in the shape of a reduction in stability, caused by phase separation during recording or storage.

In order to avoid the foregoing problems, for example, S. Hvilsted et al. have proposed holographic recordings in which refractive index gratings are written with the use of a polymer having cyanoazobenzene in its side chain (for example, see Opt. Lett., 17[17], 1234-1236, 1992). In this material, for example, 2500 high and low refractive index gratings can be written within a space of 1 mm. Thus, this material is expected to achieve a high degree of recording density.

The holographic memory to a polymer film having azobenzene in its side chain is based on photo-induced anisotropy of the polymer film. In the amorphous azopolymer film, the azobenzene has a random orientation. When linearly polarized light with a wavelength corresponding to the absorption band which belongs to the π−π* transition of the azo group is applied to the azopolymer film as excitation light, as the transition dipole moment approaches the polarization direction (in other words, as selective excitation occurs), there is a greater probability of azobenzene having trans-form being photoisomerized into one having cis-form. The cis-form thus excited can also be isomerized back into a trans-form by light or heat.

After the angle-selective trans-cis-trans isomerization cycle has been achieved by means of the application of polarized light, an orientation of the azobenezene is shifted towards a direction that is stable against the excitation light, specifically towards a direction perpendicular to the polarization direction. As a result of this change in orientation, an azobenzene having optical anisotropy exhibits birefringence or dichroism. With the use of such photo-induced anisotropy, holographic recording is possible by means of intensity distribution or polarization distribution. Since the record is formed by means of this change in polymer orientation, the record is stable over a long period of time and can be erased by the application of circularly polarized light, or by heating the isotropic phase. Rewriting therefore become possible. The film of such a polymer having azobenzene in its side chain is the most promising material for rewritable holographic memories.

As such a material, some holographic recording materials are disclosed which contain an azobenzene-containing polymer having in a side chain an azobenzene moiety with a specific structure and having an acrylate or a methacrylate structure as a main chain. However, such materials have not proved to be sufficient for optical recording media in view of sensitivity (recording speed) and recording density (for example, see Japanese Patent Applications National Publication (Laid-Open) Nos. 2000-514468 and 2002-539476, U.S. Pat. No. 6,441,113 B1 and Japanese Patent Application Laid-Open (JP-A) No. 10-212324).

The inventors have already proposed a polyester having azobenzene in its side chain, which, as mentioned above, can be useful as an optical recording material. More specifically, a monomer has been disclosed whose absorption band is controlled, by the introduction to azobenzene of a methyl group, within a certain region suitable for optical recording, as well as a polyester thereof and an optical recording medium using these materials (for example, see JP-A No. 2000-109719). The inventors have also proposed a polyester suitable for optical recording, a polyester which has a specified methylene chain in its main chain and has a controlled glass transition temperature, and an optical recording medium using the polyester (for example, see JP-A No. 2000-264962). It has also been disclosed that a polyester having a specified methylene chain in its side chain can secure improved optical recording characteristics (for example, see JP-A No. 2001-294652).

With regard to volume-type holographic memories, making a thick film for recording media is most important for purposes of achieving large capacity. In general, as the thickness of a hologram increases, the incident angle conditions for diffraction become severer, and even a slight deviation from the Bragg condition can lead to a loss of diffracted light. The angle-multiplexed method for volume-type holographic memories is based on this angle selectivity. In such a method, a number of holograms are formed within the same material, and since the incident angle of the readout light can be regulated, a desired hologram can be read out with no crosstalk. If angle selectivity is improved by increasing the film thickness of the recording medium, multiplicity can be increased and recording capacity can accordingly also be enhanced.

The magnitude of refractive index modulation for forming holograms has a limit depending on the capacity of the medium material. Therefore, production of a number of holograms within the same material means that when the holograms are used this may be tantamount to the refractive index-modulating capacity of the material being reduced in relation to the number of holograms. Diffraction efficiency can be a function of almost the square of the refractive index amplitude. Therefore, when multiplicity is increased, the diffraction efficiency of the hologram can decrease in proportion to the square of the multiplicity. Therefore, it is desirable to develop a recording medium which can secure a reasonable level of diffraction efficiency even when the degree of multiplicity is increased.

On the other hand, a film of the polymer having azobenzene in a side chain thereof should be recorded at a wavelength at which the π−π* transition of azobenzene can be excited by the mechanism described above. For improving recording sensitivity, selection of a highly absorptive wavelength is effective. However, as another result, high diffraction efficiency becomes difficult to realize due to absorption loss of the medium. Accordingly, the concentration of a coloring matter such as azobenzene in a medium should be regulated suitably in order to achieve both recording sensitivity and diffraction efficiency.

As a method of regulating the concentration of a coloring matter without deteriorating recording characteristics, there is a method which involves introducing non-photoresponsive mesogenic groups into a polymer chain. The non-photoresponsive mesogenic groups change their orientation accompanying a change in the orientation of azobenzene (cooperative effect), thus enabling the concentration of a coloring matter to be changed while maintaining recording characteristics. With direct light, however, these non-photoresponsive mesogenic groups are not induced to change their orientation, and therefore, when the content of photoresponsive groups is lowered and the thickness of the film is increased, the effective cooperative effect cannot be demonstrated.

Further, if a material is used that has a high capacity of absorption at the recording wavelength, the incident recording light may be absorbed by molecules in a vicinity of the surface of the medium, and accordingly holograms can no longer be effectively formed over the entire area in a film thickness direction of the medium. It is known that if the refractive index amplitude for a hologram is impaired in the film thickness direction, angle selectivity for diffraction efficiency may be adversely affected. Such a degradation in angle selectivity can lead to crosstalk between multi-recorded holograms, and thus lead to a reduction in the S/N ratio.

### SUMMARY OF THE INVENTION

The present invention is made in view of the above circumstances and provides an optical recording material including photoresponsive groups different in absorption spectrum intermingled in the material thereby enabling the density of coloring matter to be easily regulated without deteriorating recording characteristics depending on the thickness of a medium or the like. The invention also provides an optical recording medium capable of large-capacity recording by thickening a photosensitive layer without deteriorating recording characteristics such as the angle selectivity of diffraction efficiency. Further, the invention provides an optical recording reproduction apparatus capable of recording and reproducing large-capacity data.

That is, the invention provides an optical recording material for recording information by utilizing a change in absorption, a change in refractive index or a change in shape accompanying irradiation with light, the material comprising a polymer or an oligomer which has a side chain containing one or more mesogenic groups and linked to a main chain and which contains two or more kinds of photoresponsive groups, each of which are different in absorption spectrum.

The invention further provides an optical recording medium comprising, in a photosensitive layer, the optical recording material.

The invention furthermore provides an optical recording reproduction apparatus for recording and/or reproducing information by using the optical recording material.

### BRIEF DESCRIPTION OF THE DRAWINGS

Preferable embodiments of the invention will be described in detail based on the following figures, wherein:

FIG. 1 is a schematic view showing one example of an optical recording reproduction apparatus of the invention;

FIG. 2 is sectional view showing the constitution of a spatial light modulator used in the optical recording reproduction apparatus of the invention; and

FIG. 3 is a schematic view showing another example of the optical recording reproduction apparatus of the invention.

### DETAILED DESCRIPTION OF THE INVENTION

Hereinafter, the present invention is described in detail.

Optical Recording Material

The optical recording material of the invention is an optical recording material recording information by utilizing a change in absorption, a change in refractive index or a change in shape accompanying irradiation with light, which includes a polymer or oligomer having moieties of photoresponsive groups, the polymer or oligomer having a side chain containing one or more mesogenic groups linked to a main chain thereof and containing moieties of two or more kinds of photoresponsive groups different in absorption spectrum.

When irradiated with light, the photoresponsive group causes a change in structure, such as geometric isomerization. For example, the photoresponsive group may include an azobenzene skeleton, a stilbene skeleton or an azomethine skeleton (described later in detail), but preferably includes an azobenzene skeleton.

Preferable examples of the mesogenic group include linear mesogenic groups that are used for conventional low-molecular liquid crystals, such as a biphenyl group including a p (para)-substituted aromatic ring, a terphenyl group, a benzoate group, a cyclohexyl carboxylate group, a phenylcyclohexane group, a pyrimidine group, a dioxane group, and a cyclohexylcyclohexane group. A biphenyl skeleton-containing group (biphenyl derivative) is more preferred.

In the invention, a photoresponsive group such as azobenzene, as described above, may be incorporated into the mesogenic group.

The optical recording material of the invention is characterized by including a polymer or oligomer having a mesogenic group-containing side chain(s) linked to a main chain thereof and containing moieties of two or more kinds of photoresponsive groups different in absorption spectrum thereby permitting even a thick optical recording medium to achieve both high sensitivity and high diffraction efficiency.

Specifically, photoresponsive groups (coloring matter) different from one another in absorption spectrum (different in absorption maximum and spectrum shape) can be contained in a polymer thereby permitting photoresponsive groups reacting highly sensitively with recording light of specific wavelength and photoresponsive groups poor in sensitivity to this light and in absorption to be intermingled with each other.

In this case, even if the concentration of the coloring matter in the film is the same as when coloring matter of a single absorption spectrum is contained in the film, the amount of light absorbed by the coloring matter in the whole film can be easily regulated, and simultaneously the cooperative effect of non-photoresponsive mesogenic groups etc. can be enhanced by the function of the coloring matter poor in sensitivity to recording light, resulting in high sensitivity and high diffraction efficiency even when the film is thickened.

The phrase “different in absorption spectrum” in the invention means not only difference in absorption maximum wavelength (λmax) and spectrum shape in absorption spectrum as described above, but also difference in molar absorption coefficient of photoresponsive groups at the wavelength of light used in recording and reproduction, from the viewpoint of difference in sensitivity to light and in absorption.

Two or more kinds of photoresponsive groups different in absorption spectrum, contained in the polymer or oligomer in the invention, are preferably those wherein when the molar absorption coefficient (ε1) of one photoresponsive group is specified, the molar absorption coefficient (ε2) of the other photoresponsive group(s) is preferably separated from ε1 by 50 to 100000 M-⁻¹ cm⁻¹, and more preferably separated from ε1 by 100 to 10000 M⁻¹ cm⁻¹. When the difference in molar absorption coefficient (|ε1−ε2|) is less than 50 M⁻¹ cm⁻¹, the amount of the coloring matter is substantially not regulated, and the absorption loss cannot be reduced in some cases. On the other hand, when the difference in molar absorption coefficient (|ε1−ε2|) is greater than 100000 M⁻¹ cm⁻¹, the difference between the two coefficients is so high that the controllability of the absorption amount of the coloring matter may be lowered.

The molar absorption coefficient can be determined by measuring a visible/ultraviolet absorption spectrum of a film or solution of the polymer, oligomer or monomer containing photoresponsive groups.

In the invention, it is sufficient for the moieties of two or more kinds of photoresponsive groups different in absorption spectrum to be contained in the polymer or oligomer having mesogenic group-containing side chains linked thereto, and the form thereof is not particularly limited, but the moieties of photoresponsive groups are preferably introduced (linked) to the polymer or oligomer molecule. The resulting film can thereby not only be made uniform but also easily exhibit the cooperative effect of non-photoresponsive groups described later.

In the invention, the polymer or oligomer containing the moieties of photoresponsive groups preferably contains a copolymer having two or more photoresponsive groups different in absorption spectrum introduced into the same molecule. The site of coloring matter highly sensitive to recording light and the site of coloring matter poor in sensitivity are in regular arrangement, and thus the cooperative effect is efficiently enhanced.

The phrase “containing (the moieties of) two or more kinds of photoresponsive groups different in absorption spectrum” means that when the polymer or oligomer is viewed as a whole, there are two or more kinds of photoresponsive groups different in absorption spectrum.

In the invention, therefore, introduction of two or more kinds of photoresponsive groups different in absorption spectrum into the polymer may be conducted by using a copolymer wherein two or more kinds of photoresponsive groups different in absorption spectrum are linked to one polymer chain, or by mixing polymers and/or oligomers having two or more kinds of photoresponsive groups different in absorption spectrum introduced therein. In this case too, the same effect as achieved by the single polymer having two or more kinds of photoresponsive groups different in absorption spectrum introduced therein can be expected.

The difference in molar absorption coefficient in this case is preferably the same as described above.

In the invention, all or two or more of the mesogenic groups are preferably two or more kinds of photoresponsive groups different in absorption spectrum. As a result, the change in the orientation of the photoresponsive groups by irradiation with light can be stably recorded.

Specific examples of the mesogenic groups also serving as the photoresponsive groups will be described below.

In the invention, the mesogenic groups in side chains of the polymer or oligomer containing the moieties of photoresponsive groups preferably contain two or more kinds of photoresponsive groups different in absorption spectrum and at least one kind of non-photoresponsive group.

In this case, the non-photoresponsive group is a biphenyl derivative or the like, and the change in orientation of the photoresponsive groups by light can be enhanced and fixed (cooperative effect) by the non-photoresponsive group, as described above.

Like the above case, introduction of the non-photoresponsive group into the polymer or oligomer may be conducted by linking two or more kinds of photoresponsive groups different in absorption spectrum and at least one kind of non-photoresponsive group to one polymer chain, or by mixing a polymer or oligomer having two or more kinds of photoresponsive groups different in absorption spectrum, with a polymer or oligomer containing at least one kind of non-photoresponsive group.

In this case, the difference in molar absorption coefficient between the two or more kinds of photoresponsive groups different in absorption spectrum is also preferably the same as described above.

The photoresponsive group-containing polymer or oligomer according to the invention is described in detail below.

In the invention, the side chain that contains a mesogenic group is liked to the main chain. Preferable examples of a bivalent group that links the mesogenic group and the main chain includes a linking group of 0 to 100 carbon atoms, preferably of 1 to 20 carbon atoms, which comprises one or any combination of an alkylene group (preferably alkylene of 1 to 20 carbon atoms, such as optionally substituted methylene, ethylene, propylene, butylene, pentylene, hexylene, octylene, decylene, undecylene, and —CH₂PhCH₂— (wherein Ph represents phenylene)), an alkenylene group (preferably alkenylene of 2 to 20 carbon atoms, such as ethenylene, propenylene and butadienylene), an alkynylene group (preferably alkynylene of 2 to 20 carbon atoms, such as ethynylene, propynylene and butadiynylene), a cycloalkylene group (preferably cycloalkylene of 3 to 20 carbon atoms, such as 1,3-cyclopentylene and 1,4-cyclohexylene), an arylene group (preferably arylene of 6 to 26 carbon atoms, such as optionally substituted 1,2-phenylene, 1,3-phenylene, 1,4-phenylene, 1,4-naphthylene, and 2,6-naphthylene), a heterylene group (preferably heterylene of 1 to 20 carbon atoms, such as a bivalent group formed by extracting two hydrogen atoms from optionally substituted pyridine, pyrimidine, triazine, piperazine, pyrrolidine, piperidine, pyrrole, imidazole, triazole, thiophene, furan, thiazole, oxazole, thiadiazole, or oxadiazole), an amide group, an ester group, a sulfonamide group, a sulfonate group, a ureido group, a sulfonyl group, a sulfinyl group, a thioether group, an ether group, an imino group, and a carbonyl group.

Further, in the invention, the photoresponsive group is preferably a compound moiety that can cause a structural change when absorbing light. The absorbed light is preferably ultraviolet light, visible light, or infrared light in a range of about 200 nm to about 1000 nm, and more preferably ultraviolet light or visible light in a range of about 200 nm to about 700 nm. In the invention, the photoresponsive group preferably has molar absorption coefficient anisotropy (dichroism) or refractive index anisotropy (inherent birefringence).

The photoresponsive group preferably includes any one skeleton of azobenzene, stilbene, azomethine, stilbazolium, cinnamic acid (ester), chalcone, spiropyran, spirooxazine, diarylethene, fulgide, fulgimide, thioindigo, and indigo, more preferably comprises any one skeleton of azobenzene, spiropyran, spirooxazine, diarylethene, fulgide, and fulgimide, and is most preferably an azobenzene skeleton.

In a case where the photoresponsive group is an azobenzene skeleton-containing group is preferably represented by the formula: —Ar₁—N═N—Ar₂, wherein Ar₂ represents an aryl group (preferably aryl of 6 to 26 carbon atoms, such as phenyl, 1-naphthyl and 2-naphthyl) or a heterocyclic group (preferably a heterocyclic group of 1 to 26 carbon atoms, such as pyridyl, pyrimidyl, pyrazyl, triazyl, pyrrolyl, imidazolyl, triazolyl, oxazolyl, thiazolyl, pyrazolyl, thienyl, furyl, isothiazolyl, oxadiazolyl, thiadiazolyl, and isooxazolyl).

The aryl or the heterocyclic group may have any substituent, and preferable examples of such a substituent include an alkyl group, an aryl group, a hetero cyclic group, a halogen atom, an amino group, a cyano group, a nitro group, a hydoxyl group, a carboxyl group, an alkoxy group, an aryloxy group, an alkylsulfonyl group, an arylsulfonyl group or the like. The aryl or the heterocyclic group may form a fused ring. In such a case, the fused ring is preferably formed by fusing a benzene ring, a naphthalene ring, a pyridine ring, a cyclohexene ring, a cyclopentene ring, a thiophene ring, a furan ring, an imidazole ring, a thiazole ring, an isothiazole ring, an oxazole ring, or the like, and more preferably by fusing a benzene ring.

Preferable examples of the Ar₂ being heterocyclic group include, but are not limited to, the groups shown below, wherein the bonding arm from each ring indicates the position where the azo group is substituted.

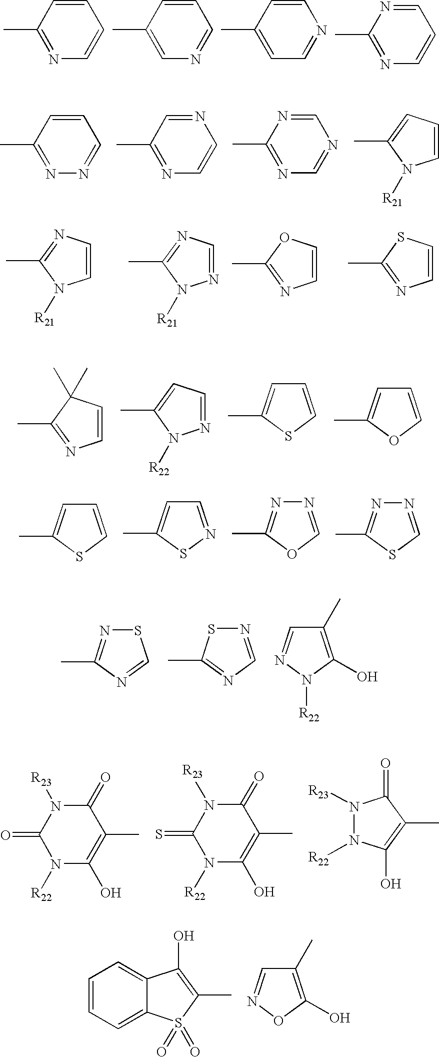

In the above formulae, R₂₁ represents a hydrogen atom or a substituent, and specific examples thereof include a hydrogen atom, an alkyl group, an aryl group, a hetero cyclic group, a halogen atom, an amino group, a cyano group, a nitro group, a hydoxyl group, a carboxyl group, an alkoxy group, an aryloxy group, an alkylsulfonyl group, an arylsulfonyl group, a sulfamoyl group, a carbamoyl group, an acylamino group, an acyloxy group, and an alkoxycarbonyl group.

Each of R₂₂ and R₂₃ independently represents a hydrogen atom, an alkyl group, an alkenyl group, a cycloalkyl group, an aryl group, or a heterocyclic group. Any hydrogen atom on the heterocyclic group may be replaced with any substituent.

Ar₁ represents an arylene group or a heterylene group. Preferred examples thereof include bivalent groups respectively formed by extracting a hydrogen atom from each of the preferred examples of the aryl group, or from the heterocyclic group for Ar₂.

When Ar₁ represents an arylene group, Ar₁ is more preferably 1,4-phenylene that may be optionally substituted. Ar₁ is more preferably an arylene group.

Specific examples of the photoresponsive group which contain an azobenzene skeleton include the structures shown below. Each of the structures is linked to a side chain or a main chain of the polymer at the position indicated by the mark *.

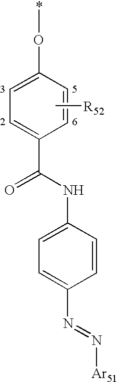

| | Ar₅₁ | R₅₂ |
|---|---|---|
| P-1 | 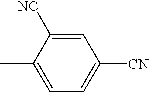 | H |
| P-2 | 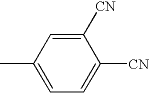 | H |
| P-3 | 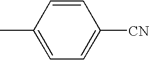 | H |
| P-4 | 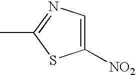 | H |
| P-5 | 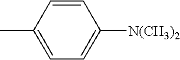 | H |
| P-6 | 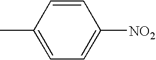 | H |
| P-7 | 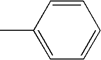 | 3-CH₃ |
| P-8 | 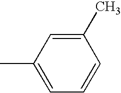 | H |
| P-9 | 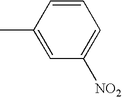 | 3-CH₃ |
| P-10 | 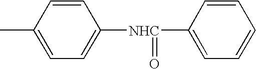 | 2-CH₃ |

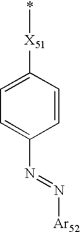

| | Ar₅₂ | X₅₁ |
|---|---|---|
| P-11 | 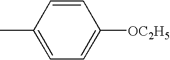 | —O— |
| P-12 | 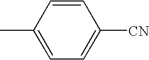 | —O— |
| P-13 | 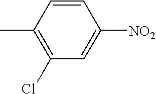 | 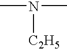 |
| P-14 | 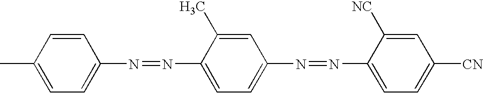 | 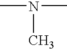 |
| P-15 | 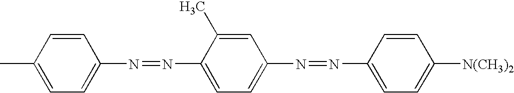 | 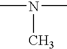 |
| P-16 | 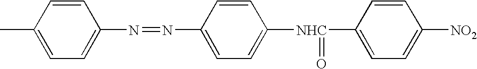 | 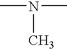 |
| P-17 | 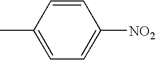 | 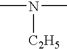 |
| P-18 | 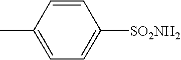 | 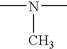 |
| P-19 | 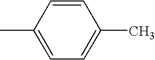 | 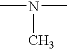 |
| P-20 | 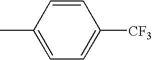 | 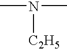 |
| P-21 | 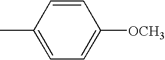 | 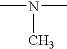 |

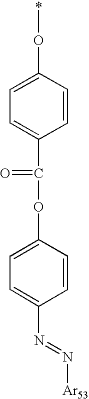

| | Ar₅₃ |
|---|---|
| P-22 | 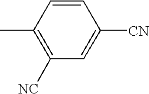 |
| P-23 | 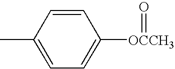 |

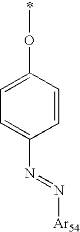

| | Ar₅₄ |
|---|---|
| P-24 | 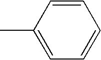 |
| P-25 | 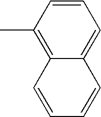 |
| P-26 | 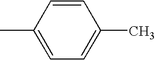 |
| P-27 | 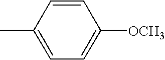 |
| P-28 | 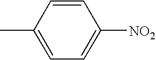 |
| P-29 | 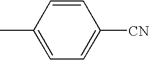 |
| P-30 | 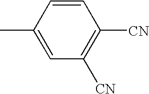 |
| P-31 | 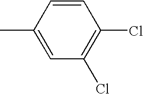 |
| P-32 | 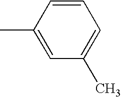 |
| P-33 | 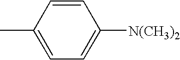 |
| P-34 | 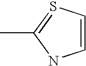 |
| P-35 | 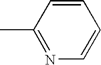 |
| P-36 | 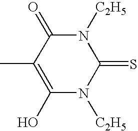 |
| P-37 | 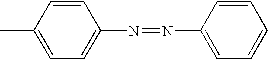 |

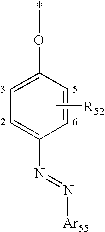

| | Ar₅₅ | R₅₂ |
|---|---|---|
| P-39 | 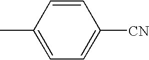 | 3-Cl |
| P-40 | 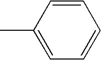 | 2-CH₃ |
| P-41 | 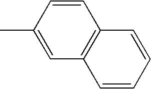 | H |
| P-42 | 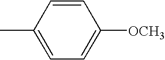 | H |
| P-43 | 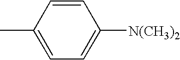 | 3-OCH₃ |
| P-44 | 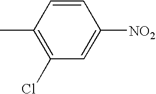 | H |
| P-45 | 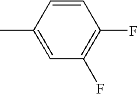 | 3-COOCH₃ |
| P-46 | 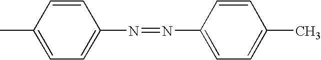 | H |
| P-47 | 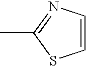 | H |
| P-48 | 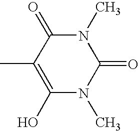 | H |
| P-49 | 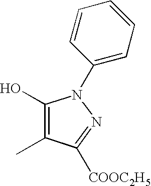 | H |
| P-50 | 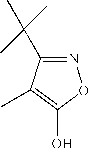 | H |

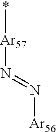

| | Ar₅₇ | Ar₅₆ |
|---|---|---|
| P-51 | 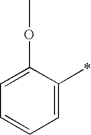 | 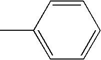 |
| P-52 | 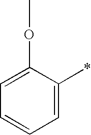 | 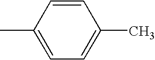 |
| P-53 | 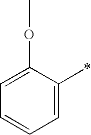 | 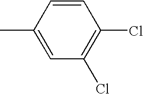 |
| P-54 | 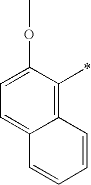 | 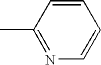 |
| P-55 | 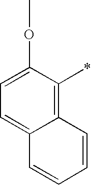 | 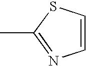 |
| P-56 | 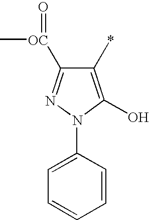 | 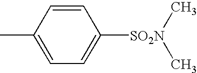 |
| P-57 | 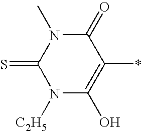 | 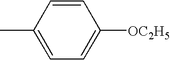 |
| P-58 | 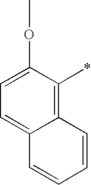 | 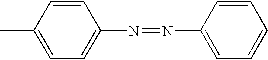 |

(Each of the mark * is linked to the structure —N═N—.)

Preferred examples of the non-photoresponsive mesogenic group of the invention include those that are used for conventional low-molecular liquid crystals, such as a biphenyl group, a terphenyl group, a benzoate group, a cyclohexyl carboxylate group, a phenylcyclohexane group, a pyrimidine group, a dioxane group, and a cyclohexylcyclohexane group. A biphenyl skeleton-containing group (biphenyl derivative) is more preferred.

In the invention, the main chain of the photoresponsive group-containing polymer or oligomer is not limited to any structure, but in a case where the main chain contains one or more organic groups having a cyclic structure, it is preferable that the photoresponsive group and/or the mesogenic group is contained in the side chain(s), and that all or part of the side chains are bound to all or part of the cyclic structure(s).

Such a structure can inhibit the production of liquid crystal resulting from the mesogenic group(s) on the side chain(s), which enables preparation of a thick film medium having little scattering noise.

In a case where the main chain contains an organic group having a cyclic structure, it is particularly preferably a polyester represented by following Formula (1). In the Formula (1), each of the marks * and *′ means that the structural units are respectively linked at positions indicated by the same mark.

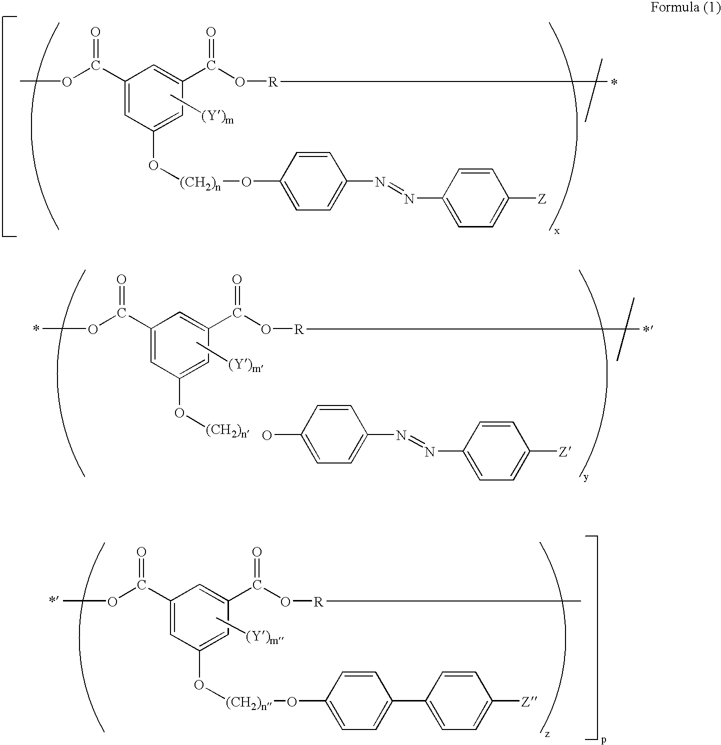

In the Formula (1) (and following Formulae (2) and (3)), Y, Y′ and Y″ each independently represents a hydrogen atom or a lower alkyl group; Z, Z′ and Z″ each independently represents a hydrogen atom, a methyl group, a methoxy group, a cyano group, or a nitro group; R represents a hydrocarbon chain containing an aromatic group, an aliphatic group, or an aromatic group and an aliphatic group which may be substituted; m, m′ and m″ each independently represents an integer of 1 to 3; n, n′ and n″ each independently represents an integer of 2 to 18; p represents an integer of 5 to 2000; and x, y and z each represents the abundance ratio of each repeating unit and satisfies the relations: 0<x≦1, 0<y≦1, 0≦z<1 and x+y+z=1

The polyester represented by Formula (1) may be produced in the presence of a suitable catalyst by the reaction of the dicarboxylic acid monomer represented by Formula (2) below, the photoresponsive dicarboxylic acid monomer represented by Formula (3) below and the diol compound represented by Formula (4) below.

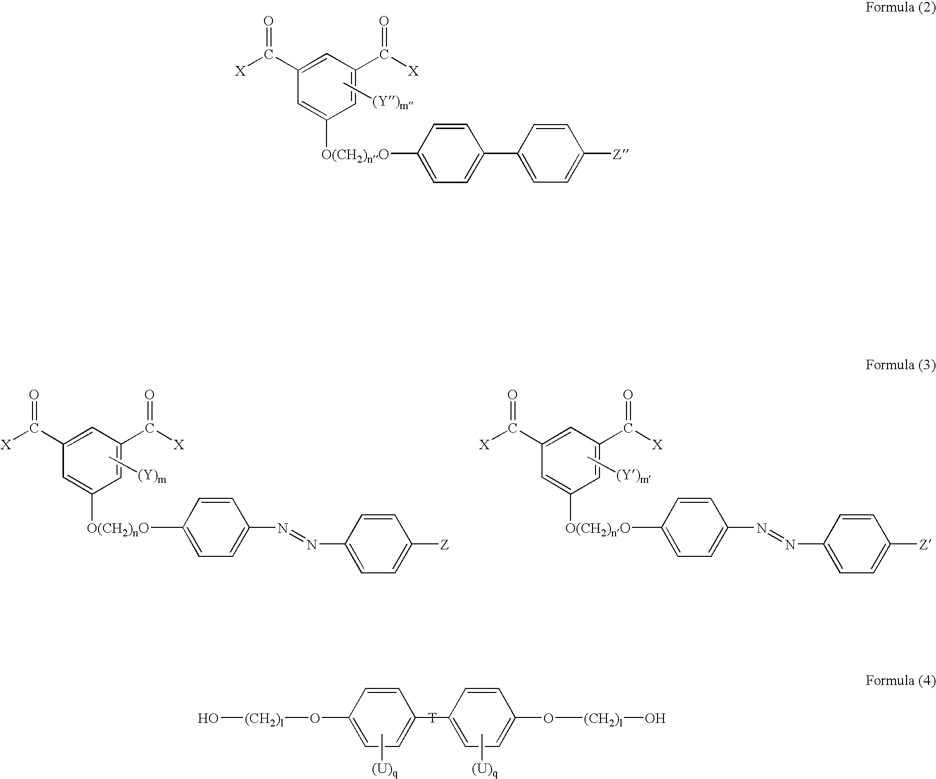

In Formula (4), U represents a hydrogen atom, a halogen atom, a substituted or unsubstituted lower alkyl group, a substituted or unsubstituted lower alkenyl group, or a substituted or unsubstituted lower alkynyl group; T represents a sulfone bond, a sulfoxide bond, an ether bond, a thioether bond, a substituted imino bond, or a ketone bond; q represents an integer of 1 to 4; and k and 1 each represents an integer of 1 to 18.

The photoresponsive group-containing polymer or oligomer according to the invention preferably has a number average molecular weight of about 1000 to about 10,000,000, and more preferably of about 10,000 to 1,000,000.

These polymers or oligomers may be synthesized on the basis of known synthesis methods as disclosed in JP-A Nos. 2001-294652 and 2000-264962, Japanese Patent Application National Publication (Laid-Open) Nos. 2000-514468 and 2002-539476, U.S. Pat. No. 6,441,113 B1, and JP-A No. 10-212324.

Optical Recording Medium

Structure of Optical Recording Medium

The optical recording medium of the invention includes a photosensitive layer that contains the optical recording material of the invention.

The optical recording medium of the invention may include a substrate and a photosensitive layer containing the optical recording material. A photosensitive layer containing the optical recording material may form the whole of the optical recording medium. Any substrate may be used as long as it is transparent and tough in the operating wavelength range and free from significant variations in quality or size in normal ranges of temperature and moisture. Examples of such a substrate include soda glass, borosilicate glass, potash glass, an acrylic plate, a polycarbonate, and a polyethylene terephthalate (PET) sheet.

The optical recording medium of the invention with the optical recording material makes possible a relatively thick photosensitive layer, a merit which would have been difficult to achieve in related art. The thickness of the photosensitive layer can be varied, with no degradation in optical recording characteristics, within a range of about 20 μm to about 10 mm. The more the thickness of the photosensitive layer is increased, the more recording multiplicity can also be increased. However, the diffraction efficiency of the multiplexed holograms varies in almost an inverse ratio to the square of the multiplicity. Accordingly, thickness is preferably within a range such that a multiplicity of up to several thousands is possible, and specifically, the thickness is preferably from about 50 μm to about 1000 μm, and more preferably from about 100 μm to 2 mm.

In the recording medium of the invention, the abundance ratio of each of the two or more photoresponsive groups which have different absorption spectrums and which are introduced into the photoresponsive group-containing polymer(s) or oligomer(s) is preferably varied in the film thickness direction (the direction of travel of the recording light from a surface side of the photosensitive layer).

Thus, the attenuation of the refractive index amplitude caused by an absorption loss of recording light in the depth direction of the recording medium can be controlled by varying the abundance ratio in the film thickness direction from the surface of the optical recording medium, whereby the sensitivity and the saturation value of the entire layer can be improved.

In the invention, it is particularly preferable that the abundance ratio of a photoresponsive group has been increased in the direction of film thickness of the photosensitive layer from a surface side of the photosensitive layer since it efficiently improves the sensitivity and the saturation value.

At an operating wavelength the optical recording medium of the invention preferably has a transmittance or reflectivity of from about 40 to about 90%, and more preferably of from about 50 to about 80%. If transmittance or reflectivity is less than about 40%, circumstances can arise when it becomes difficult to achieve a high level of diffraction efficiency because of absorption loss. If, on the other hand, transmittance or reflectivity exceeds about 90%, it can be difficult to achieve a high degree of sensitivity because of a reduction in the amount of the dye.

The optical recording medium of the invention may be formed in either a two or three-dimensional shape such as the shape of a sheet, a tape, a film or a disc. For example, one concrete method of forming the optical recording medium includes the steps of: dissolving the optical recording material in an aliphatic or aromatic, halogenated or ether solvent such as chloroform, methylene chloride, o-dichlorobenzene, tetrahydrofuran, anisole, and acetophenone; and applying the solution to a substrate such as glass to form a transparent, tough, film-shaped, optical recording medium. Alternatively, a film-shaped medium can be formed by heating and compressing a powdered, pelleted or flaked solid of the optical recording material by a method such as hot-press method.

Preferred embodiments of the optical recording medium of the invention include the following: (1) a disc-shaped optical recording medium on, or from, which recording or reproduction can be performed by rotating it and scanning it with a recording/reproducing head along its radius; (2) a sheet-shaped optical recording medium on, or from, which recording or reproduction can be performed by scanning it with a recording/reproducing head in two-dimensional directions; (3) a tape-shaped optical recording medium on, or from, which recording or reproduction can be performed by winding it and scanning a certain part of it with a recording/reproducing head; (4) a three-dimensional bulk-shaped optical recording medium on, or from, which recording or reproduction can be performed by anchoring it or fixing it onto a movable stage and scanning the surface or inside thereof with a movable or fixed recording/reproducing head; and (5) an optical recording medium which contains appropriately-laminated film-shaped components and has a two-dimensional shape such as a disc shape, a sheet shape and a card shape, or alternatively has some other three-dimensional shape and on, or from, which recording or reproduction can be performed by scanning it with a recording/reproducing head based on any one, or any combination, of the methods described in the above items (1) to (4).

Applicable Recording Methods

The optical recording medium of the invention is for use in optical recordings which are effected by means of a change, or variation, in absorption, refractive index or shape of the optical recording material that take place when light, or heat, is applied to the optical recording material. Examples of such an optical recording method include holographic recording, light absorbance modulation recording, light reflectivity modulation recording, and photo-induced relief formation. In particular, the optical recording medium of the invention is suitable for holographic recording, a process which can be performed on the basis of the amplitude, phase and polarization direction of object light. When the optical recording medium of the invention is used, recording with parallel polarization directions of incident object light and reference light can be performed independently of recording with perpendicular polarization directions of incident object light and reference light. The polarization arrangement of the two lightwaves in holographic recording is not limited to those stated above. Any other arrangement may be selected, as long as it can produce optical intensity distribution or polarization distribution by means of interference.

Optical Recording/Reproducing Device

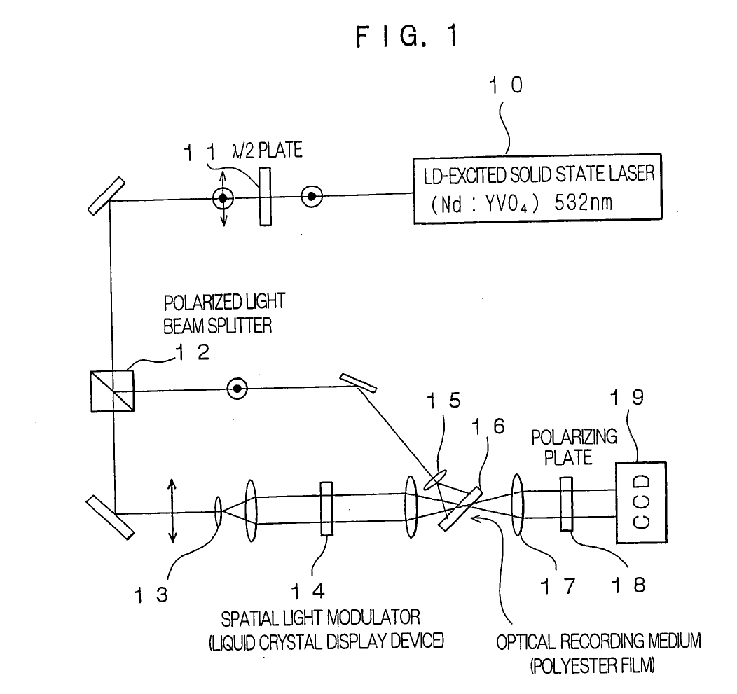

FIG. 1 illustrates an example of the optical recording/reproducing device of the invention.

This example uses an oscillation line with a wavelength of 532 nm from a laser diode-excited solid state laser. The laser beam emitted from the solid state laser 10 passes through a ½ wave plate 11 and is transmitted to a polarized beam splitter 12 to be divided into two lightwaves, signal light and reference light. The signal light is expanded and collimated by a lens system 13 and passes through a spatial light modulator 14. At this time, certain data which has been encoded in accordance with the information is expressed by light and shade on a liquid crystal display (the spatial light modulator 14) and imparted to the signal light. The signal light is then Fourier-transformed by a lens and applied to an optical recording medium 16. The reference light is formed into a spherical wave through a lens 15 placed immediately before the optical recording medium 16 and applied to the optical recording medium 16 so as to be superposed on the signal light in the medium 16. Thus, the information imparted to the signal light is recorded into the optical recording medium in the form of a hologram.

As for the thick hologram, as mentioned above, volume-multiplexed recording is possible by hologram selectivity on the basis of the incident angle of reference light. When recording is performed with the use of a spherical reference wave, shifting the record medium in a surface direction is in practice tantamount to varying the incident angle of reference light onto an effectively recorded hologram. Thus, if recording is performed while the optical recording medium 16 is being shifted in a situation in which the paths of signal light and reference light are fixed, volume-multiplexed recording can easily be achieved. This example illustrates a spherical reference wave-shift multiplexing method. However, the multiplexing method is not limited to such a method, and any other multiplexing method, such as angle multiplexing, polarization angle multiplexing, correlation multiplexing, and wavelength multiplexing may also be used.

The light source may emit coherent light to which the recording layer (photosensitive layer) of the optical recording medium 16 is sensitive. In a case where the optical recording material of the invention is used for the recording layer, the light source is preferably a laser diode-excited solid state laser with an oscillation wavelength of 532 nm, or an argon ion laser with an oscillation wavelength of 515 nm, wherein the oscillation wavelength corresponds to the edge of the absorption peak of the optical recording medium 16.

The spatial light modulator 14 used may be a transmission type spatial light modulator which contains an electro-optical converting material such as a liquid crystal, and transparent electrodes formed on both sides of the electro-optical converting material. Such a type of spatial light modulator may be a liquid crystal panel for use in a projector.

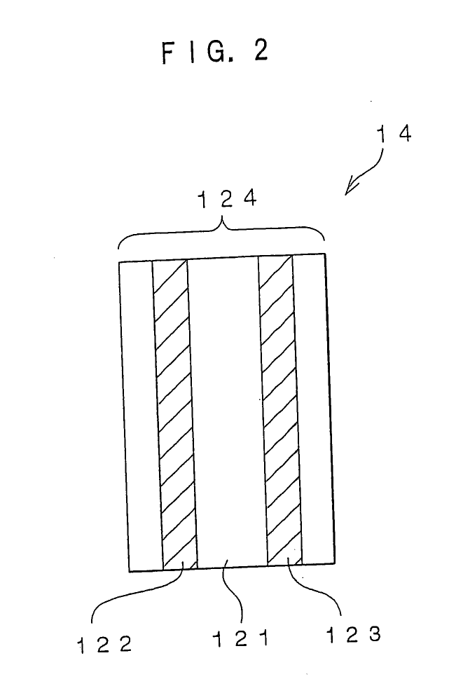

However, if polarization modulation is to be performed with the use of the liquid crystal panel as a projector, at least a polarizing plate placed on the output side must be removed. As shown in FIG. 2, for example, the spatial light modulator 14 may be a transmission type liquid crystal cell 124 which contains a liquid crystal 121, which is an electro-optical converting member, and electrodes 122 and 123 formed on both sides of the liquid crystal 121. In this spatial light modulator for polarization modulation, multiple two-dimensional pixels are arranged, and each pixel is allowed to function as a ½ wave plate. In accordance with the two-dimensional data, bit information is provided as an indication of whether or not applied voltage exists for each pixel, and polarization of incident light on each pixel can be modulated. With the use of a spatial light modulator of this kind, information can thus be recorded through polarization modulation in which signal light is encoded in a polarization direction.

Reproduction is performed by applying only reference light to the optical recording medium 16. Diffracted light is Fourier-transformed by a lens 17. A component with a polarization angle desired is selected by the polarizing plate 18, thus enabling an image to be formed on a CCD camera 19. The intensity distribution reproduced by the CCD camera 19 is binarized with a sustainable threshold value and decoded by an appropriate method so that the recorded information is reproduced.

The recording device and the reproduction device may be integrated as shown in FIG. 1, or alternatively each may be independently constructed. The light source for reproduction may use the same wavelength as that of the recording light. Alternatively, the light source for reproduction may be something akin to a helium-neon laser with an oscillation wavelength of 633 nm to which the recording layer is not sensitive (or shows no absorption). It accordingly becomes possible for the recorded information to be read out without being destroyed.

As described above, a thick highly sensitive medium for achieving a high level of diffraction efficiency can be produced with the use of the optical recording material of the invention. Such a medium can significantly enhance volume multiplicity in holographic recording and can thus be used as a large-capacity optical recording medium. Additionally, the direction of the polarization of signal light can be recorded on the optical recording medium of the invention. Accordingly, on the basis of polarization recording, the medium can be used as either a large-capacity recording method or as a light-processing method. A large-capacity optical recording/reproducing device which can use any of these optical recording media can also be provided.

### EXAMPLES

Hereinafter, the present invention is described in more detail by reference to examples.

Preparation of Optical Recording Materials

Synthesis of Various Monomers

Synthesis of photoresponsive side-chain monomer 1 (dicarboxylic acid monomer carrying methylazobenzene)

### Synthesis of 4-hydroxy-4′-methylazobenzene

750 ml of 6 N hydrochloric acid is introduced into a 3-L beaker, 107 g (1 mol) of finely ground p-anilidine (4-methylaniline) is introduced therein and sufficiently suspended under stirring, and the system is cooled by adding about 300 g of ice. Separately, 80 g (1.16 moles) of sodium nitrite is dissolved in 500 ml water, and 400 ml of the resulting solution is introduced over about 20 minutes into the above suspension. After the dropwise addition, the solution is stirred at about 5° C. for 1 hour. A solution of 94 g (1 mol) of phenol in 1 L of 2 N potassium hydroxide is added gradually to and mixed with the solution and then reacted overnight. After the reaction is finished, the formed precipitates are separated by filtration and dried under reduced pressure to give 210 g of crude 4-hydroxy-4′-methylazobenzene (almost quantitatively).

### Synthesis of 4-(6-bromohexyloxy)-4′-methylazobenzene

42.4 g (0.2 mol) of the synthesized 4-hydroxy-4′-methylazobenzene, 448 g (2 moles) of 1,6-dibromohexane, and 212 g (1.5 moles) of potassium carbonate anhydride are placed in a 2-L three-necked flask equipped with a mechanical stirrer, and after 800 ml of acetone is added thereto, the mixture is suspended under stirring. This reaction system is heated until the acetone is refluxed, to react the hydroxy azobenzene with the bromoalkane. After the mixture is reacted for 20 hours, insoluble salts are filtered off, and the system is concentrated to a volume of about ⅓ with a rotary evaporator. When this system is refrigerated in a refrigerator, 4-(6-bromohexyloxy)-4′-methylazobenzene is crystallized.

The product is filtered, then washed with a small amount of cold acetone, cold ether and n-hexane in this order, and dried under reduced pressure to give 38.1 g of crude 4-(6-bromohexyloxy)-4′-methylazobenzene (yield: 50.8%). This product is recrystallized from ethanol to give 31.5 g of 4-(6-bromohexyloxy)-4′-methylazobenzene (yield: 42.0%). According to analysis by high speed liquid chromatography, its purity is 98.6% or more.

### Synthesis of diethyl 5-hydroxyisophthalate

182.1 g (1 mol) of 5-hydroxyisophthalic acid, 1500 ml of ethanol and 10 ml of concentrated sulfuric acid are introduced into a 2-L three-necked flask and reacted under reflux for 24 hours in a water bath. The reaction solution is concentrated in a rotary evaporator, poured into an aqueous solution of NaHCO₃, then filtered, and dried under reduced pressure to give 228.7 g (0.96 mol) of diethyl 5-hydroxyisophthalate (yield: 96.0%). The product is recrystallized from ethanol and then dried under reduced pressure at 50 to 60° C.

### Synthesis of side-chain monomer 1 (diethyl 5-{6-[4-(4′-methylphenylazo) phenoxy] hexyloxy} isophthalate) (Exemplary Compound (I) below)

16.7 g (0.07 mol) of the synthesized diethyl 5-hydroxyisophthalate, 26.3 g (0.07 mol) of 4-(6-bromohexyloxy)-4′-methylazobenzene and 15.1 g (0.11 mol) of potassium carbonate anhydride are put in a 1-L three-necked flask, and after 300 ml of acetone is added thereto, the system is reacted under reflux by heating for 24 hours. After the reaction is finished, the system is introduced into 1500 ml of cold water, and the product is separated by filtration and dried under reduced pressure to give 30.9 g of diethyl 5-{6-[4-(4′-methylphenylazo) phenoxy] hexyloxy} isophthalate (yield: 83.0%).

This product is recrystallized twice from acetone to give 29.2 g of the objective product diethyl 5-{6-[4-(4′-methylphenylazo) phenoxy] hexyloxy} isophthalate (yield: 78.2%). According to analysis by high speed liquid chromatography, its purity is 98.5% or more.

The maximum absorption wavelength (λmax) in an absorption spectrum of this compound is 345 nm, the maximum molar absorption coefficient (εmax) at this wavelength is 25406 M⁻¹ cm⁻¹, and the molar absorption coefficient at 532 nm is 53 M⁻¹ cm⁻¹. When the infrared absorption spectrum (IR) of the resulting compound is measured for, the following results are obtained.
Characteristic IR absorption peaks: 2938 cm⁻¹ (CH stretching vibration), 1716 cm⁻¹ (ester C═O), 1601 cm⁻¹(C═C), 1580 cm⁻¹ (N═N), 1246 cm⁻¹ (C—O—C). 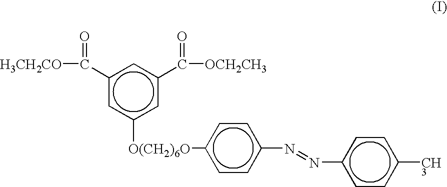
Synthesis of photoresponsive side-chain monomer 2 (dicarboxylic acid monomer carrying cyanoanobenzene)

### Synthesis of 4-hydroxy-4′-cyanoazobenzene

236.3 g (2 moles) of 4-aminobenzonitrile, 600 ml of 12 N hydrochloric acid and 600 ml of pure water are mixed under stirring in an ice bath, and an aqueous solution of NaNO₂ (solution of 150 g NaNO₂ in 750 ml of pure water) is added dropwise thereto. Then, 191.8 g (2 moles) of phenol and 112.3 g (2 moles) of KOH are dissolved rapidly in about 2 L of pure water, and the above mixture is added dropwise thereto. After filtration under suction, the product is washed with pure water, dried under reduced pressure, and then recrystallized from methanol to give 292.4 g (1.31 moles) of 4-hydroxy-4′-cyanoazobenzene (yield: 65.5%).

### Synthesis of 4-(6-bromohexyloxy)-4′-cyanoazobenzene

44.6 g (0.2 mol) of the synthesized 4-hydroxy-4′-cyanoazobenzene, 488.1 g (2 moles) of 1,6-dibromohexane, 200.4 g (1.45 moles) of K₂CO₃, and 800 ml of acetone are introduced into a 2-L three-necked flask and reacted under reflux for 20 hours in a water bath. The reaction solution is cooled to room temperature, and then byproducts and an excess of K₂CO₃ are removed by filtration. Then, the reaction solution is concentrated to a volume of about ½ in a rotary evaporator and then left in a refrigerator to form crystals. After filtration under suction, the crystals are washed with n-hexane and dried under reduced pressure to give 45.3 g (0.117 mol) of the product (yield: 58.6%). Further, this product is recrystallized from ethanol to give 36.3 g (0.094 mol) of 4-(6-bromohexyloxy)-4′-cyanoazobenzene (yield: 47.0%).

### Synthesis of side-chain monomer 2 (diethyl 5-{6-[4-(4′-cyanophenylazo) phenoxy] hexyloxy}isophthalate (Exemplary Compound (II) below)

30.9 g (0.08 mol) of the synthesized 4-(6-bromohexyloxy)-4′-cyanoazobenzene, 19.1 g (0.08 mol) of the above diethyl 5-hydroxyisophthalate, 16.58 g (0.12 mol) of K₂CO₃ and 400 ml of acetone are introduced into a 1-L three-necked flask and reacted for 24 hours under reflex in a water bath. The reaction solution is left, cooled and poured into about 4-L of pure water, and the resulting precipitates are filtered, removed and dried under reduced pressure to give 38.8 g (0.071 mol) of the product (yield: 89.2%).

Thereafter, this product is recrystallized from acetone to give 31.4 g (0.058 mol) of a side-chain monomer diethyl 5-{6-[4-(4′-cyanophenylazo) phenoxy] hexyloxy}isophthalate (yield: 72.2%). The melting point of this compound is 99.0° C., the maximum absorption wavelength (λmax) in the absorption spectrum is 364.2 nm, the maximum molar absorption coefficient (εmax) at this wavelength is 27983 M⁻¹ cm⁻¹, and the molar absorption coefficient at 532 nm is 155 M⁻¹ cm⁻¹. 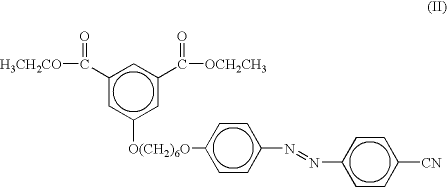
Synthesis of a non-photoresponsive side-chain monomer 3 (dicarboxylic acid monomer carrying cyanobiphenyl)

### Synthesis of 4-(6-bromohexyloxy)-4′-cyanobiphenyl

39 g (0.2 mol) of 4-hydroxy-4′-cyanobiphenyl, 487.5 g (2 moles) of 1,6-dibromohexane, 200 g (1.45 moles) of potassium carbonate anhydride and 800 ml of acetone are introduced into a 2-L three-necked flask equipped with a mechanical stirrer, and reacted for 20 hours under reflux in a water bath. After the reaction solution is cooled to room temperature, insoluble salts are filtered off. The filtrate is concentrated in a volume of about ½ in a rotary evaporator, then 500 ml of hexane is added thereto, and the mixture is heated under stirring, then left, cooled to room temperature and left in a refrigerator to form crystals. Then, the crystals are filtered under suction, washed with n-hexane and dried under reduced pressure to give 61.3 g of the crude objective product (yield: 85%). The product is further recrystallized from ethanol to give the crude objective product 4-(6-bromohexyloxy)-4′-cyanobiphenyl, 41.8 g (yield: 58%).

### Synthesis of side-chain monomer 3 (diethyl 5-{6-[4-(4′-cyanophenyl) phenoxy] hexyloxy}isophthalate) (Exemplary Compound (III) below)

28.8 g (0.08 mol) of the synthesized 4-(6-bromohexyloxy)-4′-cyanobiphenyl, 16.6 g (0.08 mol) of the above diethyl 5-hydroxyisophthalate, 19.2 g (0.12 mol) of potassium carbonate anhydride and 400 ml of acetone are introduced into a 1-L three-necked flask and reacted for 24 hours under reflux in a water bath. The reaction solution is left, cooled and poured into about 4 L of pure water, and precipitates as the crude objective product are removed by filtration and dried under reduced pressure to give 37.1 g of the product (yield: 90.0%). Thereafter, this product is recrystallized from acetone, whereby 30.2 g of diethyl 5-{6-[4-(4′-cyanophenyl) phenoxy] hexyloxy}isophthalate carrying cyanobiphenyl via a hexyl group is obtained (yield: 73.2%). As a result of mass spectrometry of this compound, a peak corresponding to a molecular weight of 515.6 is confirmed.

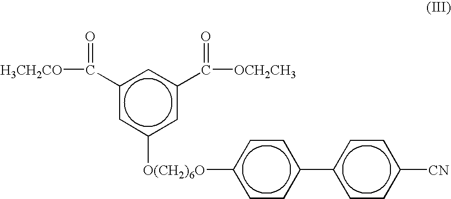

### Synthesis of main-chain monomer 1 (6,6′-(4,4′-sulfonyldiphenylenedioxy) dihexanol) (Exemplary Compound (IV) below)

82.3 g (0.3 mol) of 4,4′-sulfonyl diphenol, 90.2 g (0.66 mol) of 6-chloro-1-hexanol and 97 g (0.7 mol) of potassium carbonate anhydride are introduced into a 1-L three-necked flask, then 250 ml of N,N-dimethylformamide is added thereto, and the mixture is suspended under stirring. Then, the system is heated at 160° C. in an oil bath and reacted for 24 hours. Thereafter, the reaction solution is introduced into water containing a small amount of hydrochloric acid, and the formed white powdery material is separated by filtration and dried to give the crude objective product. This product is further recrystallized from a water/N,N-dimethylformamide system to give 120.6 g of purified 6,6′-(4,4′-sulfonyldiphenylenedioxy) dihexanol (yield: 89.2%).

The resulting compound is measured for IR absorption spectrum (IR). The measurement results are shown below.
Characteristic IR absorption peaks: 2937 cm⁻¹ (CH stretching vibration), 1594 cm⁻¹ (C═C), 1252 cm⁻¹ (C—O—C), 1149 cm⁻¹ (S═O). 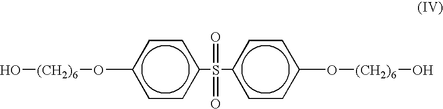
Synthesis of Various Polymers
Synthesis of Polymers 1 and 2 having a Photoresponsive Side Chain and Polymer 3 having a non-responsive side chain

2.66 g (0.005 mol) of the side-chain monomer 1, 2.25 g (0.005 mol) of the main-chain monomer 1, and 0.05 g of zinc acetate anhydride are put in a 300-ml three-necked flask equipped with a vacuum machine and a stirring device, and then reacted at 160° C. for 2 hours and at about 1.3×10³ Pa for 20 minutes under stirring and heating in a nitrogen atmosphere. Then, the system is depressurized to about 2.7×10² Pa gradually over 30 minutes and simultaneously heated to 180° C. After the reaction is finished, the reaction product is dissolved in chloroform, and the solution is precipitated again by introducing it into methanol, to give a crude polymer. This product is precipitated again, washed under boiling with hot methanol and hot water, separated by filtration and dried under reduced pressure to give polymer 1 having methylazobenzene in a side chain thereof. The yield of polymer 1 is 83.7% (3.73 g), and the number-average molecular weight is 8540.

By the same method, polymer 2 having cyanoazobenzene in a side chain thereof is synthesized from the side-chain monomer 2, and polymer 3 having cyanobiphenyl in a side chain thereof is synthesized from the side-chain monomer 3. The yields are 87.8% (3.96 g) and 58.0% (2.53 g) respectively, and the number-average molecular weights are 8200 and 7800 respectively.

Preparation of Optical Recording Materials

Preparation of Optical Recording Materials 1 and 2

An optical recording material 1 (the recording material of the invention) having the polymer containing methylazobenzene in a side chain thereof blended with the polymer having cyanoazobenzene in a side chain thereof, and an optical recording material 2 having the polymer containing cyanoazobenzene in a side chain thereof blended with the polymer having cyanobiphenyl in a side chain thereof, are prepared in the following manner.

0.69 g of the polymer 1 having methylazobenzene in a side chain thereof and 0.23 g of the polymer 2 having cyanoazobenzene in a side chain thereof are dissolved in 10 ml of tetrahydrofuran and stirred by a stirrer. After the tetrahydrofuran is evaporated, the mixture is dried under reduced pressure to prepare the optical recording material 1 as a polymer blend. Similarly, 0.27 g of the polymer 2 having cyanoazobenzene in a side chain thereof and 0.61 g of the polymer 3 having cyanobiphenyl in a side chain thereof are used to prepare the optical recording material 2 as a polymer blend.

Preparation of Optical Recording Material 3

An optical recording material 3 (Exemplary Compound (V) below) in which monomers having two kinds of photoresponsive groups, which are different in absorption spectrum, and a monomer having one kind of non-photoresponsive group in a side chain thereof are copolymerized is prepared.

As the side-chain monomers, 1.12 g (0.0021 mol) of the side-chain monomer 1 carrying methylazobenzene, 0.38 g (0.0007 mol) of the side-chain monomer 2 carrying cyanoazobenzene, 3.71 g (0.0072 mol) of the side-chain monomer 3 carrying cyanobiphenyl, 4.51 g (0.01 mol) of the main-chain monomer 1 and 0.1 g of zinc acetate anhydride are used to synthesize the optical recording material 3 (the optical recording material of the invention) which is a copolymerized polymer having two kinds of photoresponsive groups different in absorption spectrum and one kind of non-photoresponsive group in side chains thereof by the method described above for synthesis of various polymers. The yield is 77.8% (6.84 g), and the number-average molecular weight is 9200. In the following formula, each of the marks * and *′ is linked to the same mark. 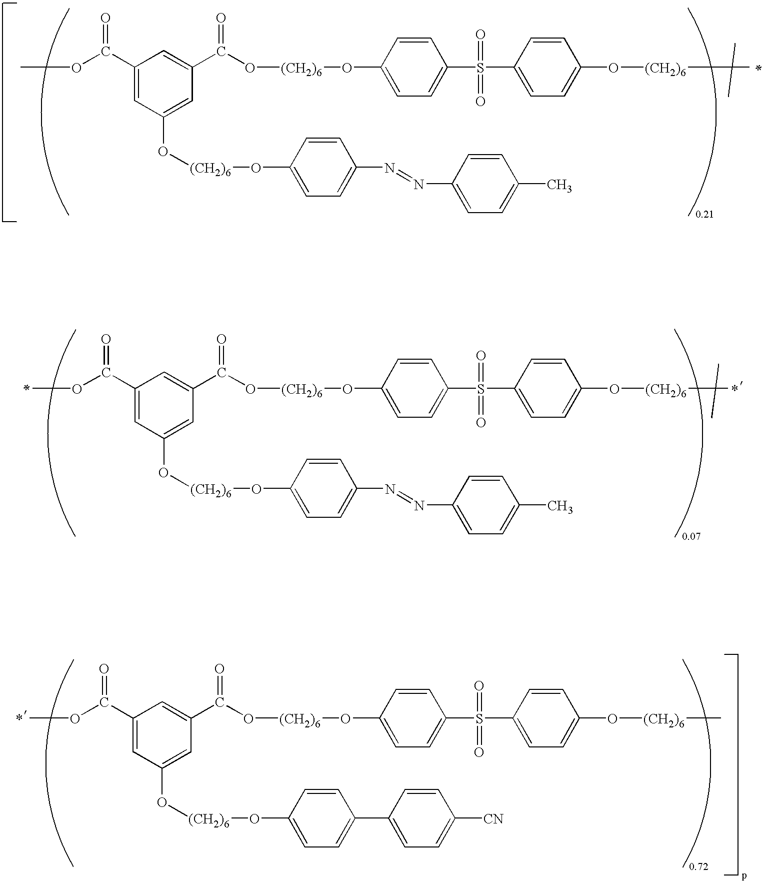
Production of Optical Recording Mediums

Production of Optical Recording Mediums 1 and 2

The optical recording materials 1 and 2 in a flaky state are placed on two washed glass substrates respectively, and a glass substrate is further placed respectively on each of the glass substrates. The substrates are heat-pressed under reduced pressure to produce sandwiched glass cell mediums having the optical recording material sandwiched between two glass substrates. In this manufacturing, a film having a thickness equal to the thickness of the optical recording material layer is used as a spacer so that the thickness of the layer is regulated to be 100 μm. Each of the optical recording mediums produced in this manner is a transparent uniform film without scattering or bubbles.

In this manner, the optical recording medium 1 (the optical recording medium of the invention) using the optical recording material 1 containing two kinds of photoresponsive groups, which are different in absorption spectrum, and the optical recording medium 2 using the optical recording material 2 prepared from a polymer containing one kind of photoresponsive group and a non-photoresponsive group so as to have absorbance almost equal to that of the medium 1, are prepared. The transmittances of the optical recording mediums 1 and 2 at 532 nm are 51% and 53% respectively.

Production of Optical Recording Medium 3

An optical recording medium 3 (the optical recording medium of the invention) is produced in the same manner as in production of the optical recording medium as described above except in that the optical recording material used is the optical recording material 3 and the thickness of the optical recording material is 250 μm. The transmittance of this optical recording medium at 532 nm is 57%.

Production of Optical Recording Medium 4

An optical recording medium 4 wherein the abundance ratio of two kinds of photoresponsive groups, which are different in absorption spectrum, is varied in the direction of thickness of the film is prepared.

This optical recording medium is produced by using the polymer 1 having methylazobenzene in a side chain thereof and the polymer 2 having cyanoazobenzene in a side chain thereof. First, the polymer 1 is hot-pressed to form a film of 85 μm in thickness on one glass substrate and the polymer 2 is hot-pressed to form a film of 30 μm in thickness on another glass substrate. Then, these are attached via a film spacer of 100 μm in thickness such that their polymer surfaces are contacted with each other and pressed at a temperature of 70° C., to give an optical recording medium 4 (the optical recording medium of the invention).

Hologram Recording Characteristics

Then, the optical recording mediums are used to evaluate hologram recording characteristics.

Hologram Recording Time

Using an optical recording reproduction apparatus shown in FIG. 1, digital data are recorded in and reproduced from the optical recording mediums 1 and 2. Each optical recording medium is used in recording with 800×660 pixels of a spatial light modulator as one page. The intensity of recording light used is 200 mW/cm². When the recording time when the bit error rate becomes 1×10⁻³ or less is confirmed, the recording time of the optical recording medium 1 containing two kinds of photoresponsive groups, which are different in absorption spectrum, is 150 msec. which is shorter than, and about 54% of, the recording time (280 msec.) of the optical recording medium 2 containing one kind of photoresponsive group. This is considered to reflect a difference in the number of azobenzens to be optically isomerized. Thus, it is found that when two kinds of optically isomerized groups, which are different in absorption spectrum, are contained, the absorbance of the medium can be easily regulated by the ratio of the two, and recording and reproduction with higher sensitivity than that achieved by the optical recording medium containing one kind of optically isomerized group are possible.

Diffraction Efficiency and Holographic Recording Characteristics

Holographic recording is next performed with the use of the optical recording medium 3.

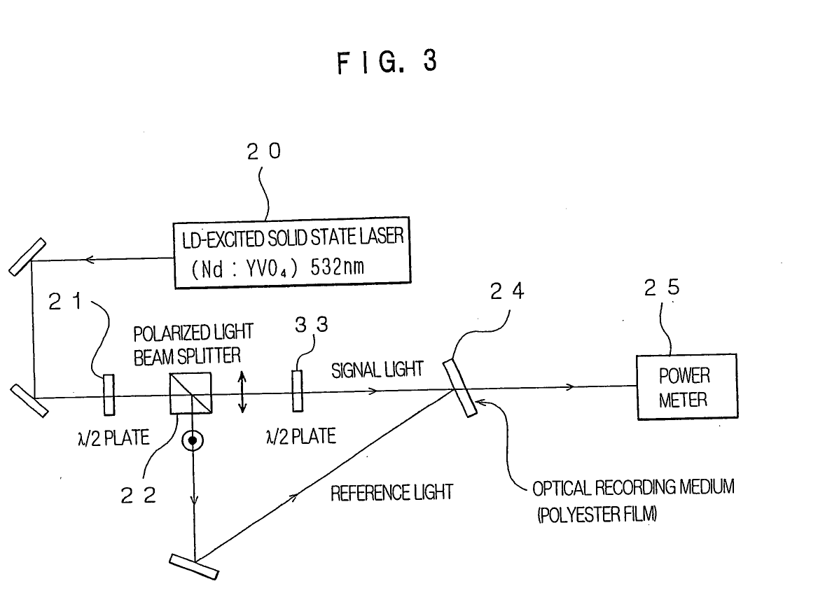

FIG. 3 shows an optical system (optical recording/reproducing device) used in the holographic recording. As shown in FIG. 3, recording/reproducing is performed with the use of a 532 nm oscillation line of a laser diode-excited solid state laser 20. The polarization of the linearly polarized light emitted from the solid state laser 20 is rotated by a ½ wave plate 21, and then the light is divided by a polarized light beam splitter 22 into two lightwaves, signal light and reference light. At this time, the intensity balance between the two lightwaves may be adjusted by controlling the rotation angle of the polarization. The two lightwaves are formed to cross each other in the optical recording medium 24 and induce optical anisotropy in the medium in accordance with intensity distribution or polarization distribution produced by interference between the two lightwaves. The ½ wave plate 33 on the path of the signal light controls the polarization of the signal light so that intensity-modulated holographic recording with parallel polarization directions of signal light and reference light, and polarization-modulated holographic recording with perpendicular polarization directions of signal light and reference light, can be performed.

In the reproduction, only reference light is applied to the optical recording medium 24 to produce diffracted light from the recorded hologram, and the light output can be measured with a power meter 25. The diffraction efficiency of the optical recording medium 24 can be calculated by determining the ratio of the diffracted light intensity to the reference light intensity.

Holographic recording is performed on the optical recording medium 3 in the above optical system. As a result, recording of an intensity-modulated hologram is possible when the polarization directions of the signal light and the reference light are parallel to each other, and recording of a polarization-modulated hologram is possible when the polarization directions of the signal light and the reference light are perpendicular to each other. Further, the maximum diffraction efficiency reaches 30%, which means that the invention can provide a thick film medium that achieves a high level of diffraction efficiency.

Next, recording/reproducing of digital data on/from optical recording medium 3 is performed using the optical recording/reproducing device as shown in FIG. 1. Specifically, 162 KB digital data is divided into 20 pages of data (each page corresponds to 800×660 pixels of the spatial light modulator) and subjected to multiplexed recording. The reproduced two-dimensional digital data page is decoded so that the recorded digital data can be reproduced. The average recording time per one hologram is 110 msec.

Thus, it is found that, in the optical recording medium of the invention, holograms can be independently recorded in each of a case where polarization directions of incident object light and reference light are parallel to each other and a case where polarization directions of incident object light and reference light are perpendicular to each other, and that the optical recording medium of the invention can achieve a high level of diffraction efficiency with a thick film, and can multiply record digital data.

Angle Selectivity of Diffraction Efficiency

Then, the optical recording medium 4, and the optical recording medium 1 having almost equal transmittance at 532 nm to that of medium 4 and having uniform distribution, in the film, of two kinds of photoresponsive groups different in absorption spectrum, are used to compare the angle selectivity of diffractive efficiency in an optical system (optical recording reproduction apparatus) shown in FIG. 3. The optical recording medium 4 is used in hologram recording from the side of the polymer 1 having a lower absorption coefficient.

Upon irradiation with reproduction light at a position deviated by about 1 degree from Bragg angle, both of the optical recording mediums exhibit the minimum diffraction efficiency. However it is found that the intensity of diffracted light of the optical recording medium 4 is about 1/20 of that of the optical recording medium 1. This is because the optical recording medium 4 is produced to exhibit lower absorption at the surface on which the recording light is incident, and thus the absorption loss of the recording light is reduced, and the decay of refractive index amplitude in the direction of thickness of the film is reduced, as compared with the optical recording medium 1. It is found that when multiple recording is conducted in this manner at the angle at which the diffraction efficiency becomes minimum, the abundance ratio of two kinds of photoresponsive groups different in absorption spectrum is changed in the direction of thickness of the film, thereby enabling reproduction of information at a high SN ratio from multiplexed hologram.

1. An optical recording material for recording information by utilizing a change in absorption, a change in refractive index or a change in shape accompanying irradiation with light, the material comprising a polymer or an oligomer which has a side chain containing one or more mesogenic groups and linked to a main chain and which contains two or more kinds of photoresponsive groups, each of which are different in absorption spectrum.

2. The optical recording material according to claim 1, wherein two or more of the mesogenic groups are two or more kinds of the photoresponsive groups.

3. The optical recording material according to claim 1, wherein all of the mesogenic groups are two or more kinds of the photoresponsive groups.

4. The optical recording material according to claim 1, wherein the polymer or the oligomer contains a copolymer having two or more kinds of the photoresponsive groups introduced into the same molecule.

5. The optical recording material according to claim 1, comprising a mixture of two or more kinds of the polymers or the oligomers each containing photoresponsive groups, each of which are different in absorption spectrum.

6. The optical recording material according to claim 1, wherein the main chain contains one or more organic groups having a cyclic structure, and all or a part of the side chains containing mesogenic groups are bound to all or a part of the cyclic structures.

7. The optical recording material according to claim 1, wherein the mesogenic groups contain two or more kinds of the photoresponsive groups and at least one kind of non-photoresponsive group.

8. The optical recording material according to claim 7, wherein the polymer or the oligomer contains a mixture of a polymer or an oligomer containing, as the mesogenic group, two or more kinds of photoresponsive groups, each of which are different in absorption spectrum, and a polymer or an oligomer containing at least one kind of non-photoresponsive group as the mesogenic group.

9. An optical recording medium comprising, in a photosensitive layer, an optical recording material for recording information by utilizing a change in absorption, a change in refractive index or a change in shape accompanying irradiation with light, the optical recording material comprising a polymer or an oligomer which has a side chain containing one or more mesogenic groups and linked to a main chain and which contains two or more kinds of photoresponsive groups, each of which are different in absorption spectrum.

10. The optical recording medium according to claim 9, wherein the abundance ratio of each of the two or more photoresponsive groups which have different absorption spectrums in the photoresponsive group-containing polymer or oligomer is varied in a film thickness direction of the optical recording medium.

11. The optical recording medium according to claim 9, wherein a thickness of the photosensitive layer is in a range of about 20 μm to about 10 mm.

12. The optical recording medium according to claim 9, wherein a transmittance or reflectivity at an operating wavelength is in a range of about 40 to about 90%.

13. The optical recording medium according to claim 9, wherein the optical recording medium is capable of hologram recording.

14. The optical recording medium according to claim 9, wherein holograms can be independently recorded in each of a case where polarization directions of incident object light and reference light are parallel to each other and a case where polarization directions of incident object light and reference light are perpendicular to each other.

15. The optical recording medium according to claim 9, wherein the optical recording medium is capable of hologram recording on the basis of the amplitude, phase and polarization direction of object light.

16. An optical recording reproduction apparatus for recording and/or reproducing information by using an optical recording material for recording information by utilizing a change in absorption, a change in refractive index or a change in shape accompanying irradiation with light, the optical recording material comprising a polymer or an oligomer which has a side chain containing one or more mesogenic groups and linked to a main chain and which contains two or more kinds of photoresponsive groups, each of which are different in absorption spectrum.
